(19) United States
(12) Patent Application Publication
(10) Pub. No.: US 2020/0173645 A1
(43) Pub. Date: Jun. 4, 2020

(54) MULTICOLOR LED DISPLAY OF ACTUATOR FUNCTION

(71) Applicant: Johnson Controls Technology Company, Auburn Hills, MI (US)

(72) Inventors: Viram Kumar Singh, Pune (IN); Duraigopal Vijayanandh, Tamilnadu (IN); Parag Jivanrao Bhongade, Wardha (IN); Lakhan Shivaji Doke, Pune (IN); Shivchandra Venkatrao Nagime, Latur (IN)

(73) Assignee: Johnson Controls Technology Company, Auburn Hills, MI (US)

(21) Appl. No.: 16/206,105

(22) Filed: Nov. 30, 2018

(51) Int. Cl. F21V 33/00; F21V 15/01; F21V 17/16; F24F 11/52; F24F 11/89

(52) U.S. Cl. CPC F21V 33/0088; F21V 15/01; F21Y 2115/10; F24F 11/52; F24F 11/89; F21V 17/164

(57) ABSTRACT

An actuator includes a housing. The housing includes a lower body. A cover assembly is coupled to the lower body. The cover assembly includes a transparent indicator disposed along a periphery of the cover assembly and adjacent to the lower body. A circuit board is disposed within the housing. The circuit board includes at least two illuminating devices disposed diagonally opposite to each other. The at least two illuminating devices illuminate the transparent indicator.

### BACKGROUND

The present disclosure relates generally to actuators in a heating, ventilating, or air conditioning (HVAC) system and more particularly to assembly of an enclosure for an HVAC actuator.

HVAC actuators are used to operate a wide variety of HVAC components, such as air dampers, fluid valves, air handling units, and other components that are typically used in HVAC systems. For example, an actuator may be coupled to a damper in an HVAC system and may be used to drive the damper between an open position and a closed position. An HVAC actuator typically includes a cable which provides and/or receives electrical signals to or from the HVAC actuator. These signals may power or control the HVAC actuator. For example, the cable may be used to power and control a display within the actuator that shows the actuator status along an edge of the actuator.

### SUMMARY

One embodiment of the present disclosure relates to an actuator that has a housing. The housing includes a lower body. A cover assembly is coupled to the lower body and includes a transparent indicator disposed along a periphery of the cover assembly and adjacent to the lower body.

In some embodiments, a circuit board disposed within the housing. The circuit board includes at least two illuminating devices disposed diagonally opposite to each other. The at least two illuminating devices illuminate the transparent indicator.

In some embodiments, the at least two illuminating devices comprise a plurality of colors, wherein the plurality of colors indicating a plurality of actuator statuses.

In some embodiments, the at least two illuminating devices comprises a first illuminating device and a second illuminating device, the first illuminating device is angled inward at a substantially 130-degree viewing angle with respect to a diagonal axis, the diagonal axis extending between the first illuminating device and the second illuminating device, the second illuminating device is angled inward at a substantially 130-degree viewing angle with respect to the diagonal axis in a direction opposite the first illuminating device.

In some embodiments, the cover assembly further comprises a top cover and a middle cover, the top cover comprising a first top surface and a second top surface, the second top surface in contact with the middle cover, and the middle cover comprising a first middle surface in contact with the second top surface and a second middle surface in contact with the lower body, wherein the transparent indicator is disposed along the first middle surface adjacent to the second middle surface.

In some embodiments, the actuator further comprises a circuit board disposed within the housing, the circuit board comprising at least two illuminating devices disposed diagonally opposite to each other, wherein the at least two illuminating devices illuminate the transparent indicator.

In some embodiments, the at least two illuminating devices comprises a first illuminating device and a second illuminating device, the first illuminating device is angled inward at a substantially 130-degree viewing angle with respect to a diagonal axis, the diagonal axis extending between the first illuminating device and the second illuminating device, the second illuminating device is angled inward at a substantially 130-degree viewing angle with respect to the diagonal axis in a direction opposite the first illuminating device.

In some embodiments, the at least two illuminating devices comprises a first illuminating device and a second illuminating device, the first illuminating device being disposed above a latitudinal axis of the circuit board and left of a longitudinal axis of the circuit board, the longitudinal axis orthogonal to the latitudinal axis, the second illuminating device being disposed below the latitudinal axis of the circuit board and right of the longitudinal axis of the circuit board.

In some embodiments, the first illuminating device is angled inward toward the longitudinal axis at a substantially 130-degree viewing angle with respect to a diagonal axis, the diagonal axis extending between the first illuminating device and the second illuminating device, the second illuminating device is angled inward toward the longitudinal axis at a substantially 130-degree viewing angle with respect to the diagonal axis in a direction opposite the first illuminating device.

In some embodiments, the diagonal axis extends at a substantially 45-degree angle through the intersection of the longitudinal axis and the latitudinal axis.

In some embodiments, the first illuminating device is angled outward away from the longitudinal axis at a substantially 130-degree viewing angle with respect the longitudinal axis, the second illuminating device is angled outward away from the longitudinal axis at a substantially 130-degree viewing angle with respect to the longitudinal axis in a direction opposite the first illuminating device.

In some embodiments, the cover assembly further comprises a top cover and a middle cover, the top cover comprising a first top surface and a second top surface, the second top surface in contact with the middle cover, and the middle cover comprising a first middle surface in contact with the second top surface and a second middle surface in contact with the lower body, wherein the transparent indicator is disposed along the first middle surface adjacent to the second middle surface.

In some embodiments, the cover assembly further comprises a plurality of snap protrusions disposed along the second middle surface, the plurality of snap protrusions extending away from the second middle surface toward the lower body, each snap protrusion in the plurality of snap protrusions configured to engage a complementary snap surface in a plurality of snap surfaces disposed along an internal surface of the lower body.

In some embodiments, the cover assembly further comprises a top cover and a middle cover, the top cover comprising a first top surface and a second top surface, the second top surface in contact with the middle cover, and the middle cover comprising a first middle surface in contact with the second top surface, a second middle surface in contact with the lower body, and a rim portion that extends out of a bottom portion of the first middle surface in a direction toward the lower body, wherein the transparent indicator is disposed along the rim portion.

In some embodiments, the rim portion is configured to engage an annular groove disposed in a first end of the lower body in a press-fit or snap-fit engagement.

In some embodiments, the at least two illuminating devices comprise a plurality of colors, wherein the plurality of colors indicating a plurality of actuator statuses.

In some embodiments, the at least two illuminating devices further comprises a plurality of patterns, wherein the plurality of colors and the plurality of patterns indicate the plurality of actuator statuses, wherein the plurality of actuator statuses comprises at least one of power up initiation failure, data corruption, a signal or stroke set point value corruption, signal loss, auto stroke, and connection status.

Another embodiment of the present disclosure relates to an actuator that has a lower body housing. A cover assembly is coupled to the lower housing body and includes a transparent indicator disposed along a periphery of the cover assembly and adjacent to the lower body. A circuit board is disposed within the lower housing body, the circuit board comprises a first illuminating device and a second illuminating device disposed diagonally opposite the first illuminating device, wherein the first illuminating device and the second illuminating device are configured to fully illuminate the transparent indicator along the periphery of the cover assembly.

In some embodiments, the at least two illuminating devices comprises a first illuminating device and a second illuminating device, the first illuminating device being disposed above a latitudinal axis of the circuit board and left of a longitudinal axis of the circuit board, the longitudinal axis orthogonal to the latitudinal axis, the second illuminating device being disposed below the latitudinal axis of the circuit board and right of the longitudinal axis of the circuit board.

In some embodiments, the first illuminating device is angled inward toward the longitudinal axis at a substantially 130-degree viewing angle with respect to a diagonal axis, the diagonal axis extending between the first illuminating device and the second illuminating device, the second illuminating device is angled inward toward the longitudinal axis at a substantially 130-degree viewing angle with respect to the diagonal axis in a direction opposite the first illuminating device.

In some embodiments, the cover assembly further comprises a top cover and a middle cover, the top cover comprising a first top surface and a second top surface, the second top surface in contact with the middle cover, and the middle cover comprising a first middle surface in contact with the second top surface, a second middle surface in contact with the lower housing body, and a rim portion that extends out of a bottom portion of the first middle surface in a direction toward the lower housing body, wherein the transparent indicator is disposed along the rim portion, and wherein the rim portion is configured to engage an annular groove disposed in a first end of the lower housing body.

Another embodiment of the present disclosure relates to a method of assembling an actuator. The method includes inserting a circuit board into a housing. The circuit board comprises a first illuminating device and a second illuminating device disposed diagonally opposite the first illuminating device. The first illuminating device and the second illuminating device are configured to fully illuminate a transparent indicator along a periphery of a cover assembly. A cover assembly is coupled to an upper end of the housing, the cover assembly comprises the transparent indicator disposed along the periphery of the cover assembly and adjacent to the upper end of the housing.

In some embodiments, the first illuminating device being disposed at a first location with respect to a latitudinal axis of the circuit board and a second location with respect to a longitudinal axis of the circuit board, the longitudinal axis orthogonal to the latitudinal axis, the second illuminating device being disposed at a third location with respect to the latitudinal axis of the circuit board and a fourth location with respect to the longitudinal axis of the circuit board, wherein the first location is opposite the third location with respect to the latitudinal axis and the second location is opposite the fourth location with respect to the longitudinal axis, and wherein the first illuminating device is angled inward toward the longitudinal axis at a substantially 130-degree viewing angle with respect to a diagonal axis, the diagonal axis extending between the first illuminating device and the second illuminating device, the second illuminating device is angled inward toward the longitudinal axis at a substantially 130-degree viewing angle with respect to the diagonal axis in a direction opposite the first illuminating device.

In some embodiments, coupling the cover assembly to the upper end of the housing comprises snap-fitting a plurality of snap protrusions of the cover assembly with a complementary plurality of snap surfaces on an internal surface of the housing, the plurality of snap protrusions extending away from a bottom edge of the cover assembly toward the housing.

### BRIEF DESCRIPTION OF THE DRAWINGS

FIG. 1 is a drawing of a building equipped with a heating, ventilating, or air conditioning (HVAC) system and a building management system (BMS), according to an exemplary embodiment.

FIG. 2 is a schematic diagram of a waterside system which may be used to support the HVAC system of FIG. 1, according to an exemplary embodiment.

FIG. 3 is a block diagram of an airside system which may be used as part of the HVAC system of FIG. 1, according to an exemplary embodiment.

FIG. 4 is a block diagram of a BMS which may be implemented in the building of FIG. 1, according to an exemplary embodiment.

FIG. 5 is an actuator which may be used in the HVAC system of FIG. 1, the waterside system of FIG. 2, the airside system of FIG. 3, or the BMS of FIG. 4 to control a HVAC component, according to an exemplary embodiment.

FIG. 6 is an exploded perspective view of the actuator of FIG. 5, according to an exemplary embodiment.

FIG. 7 is a top view of an LED configuration on the printed control board of the actuator of FIG. 5, according to an exemplary embodiment.

FIG. 8 is a top view of another LED configuration on the printed control board of the actuator of FIG. 5, according to an exemplary embodiment.

FIG. 9 is a diagram of indicator statuses, according to an exemplary embodiment.

### DETAILED DESCRIPTION

Referring generally to the FIGURES, an actuator is shown, according to an exemplary embodiment. The actuator may be an HVAC actuator, such as a damper actuator, a valve actuator, a fan actuator, a pump actuator, or any other type of actuator that can be used in an HVAC or other system.

The actuator includes a housing. The housing includes a cover assembly and a lower body. The cover assembly includes a transparent indicator disposed along a periphery of the cover assembly and adjacent to the lower body. The lower body includes a circuit board disposed within the cover assembly and the housing. The circuit board includes at least two illuminating devices disposed diagonally opposite to each other. The at least two illuminating devices illuminate the transparent indicator.

Unlike other techniques, the aspects described herein provide a uniquely designed transparent diffuser that ensures correct actuator operating condition after emitting the indicating color. A multicolor LED indicator with a variety of patterns will help in giving more options for notifying the user of the actuator status. The aspect provides a substantially 360-degree circumferential LED indicator that allows for a wide range read indication from a wide distance view, even if the actuator is mounted at different orientations. The aspects are optimized to cater to both linear and rotary valve requirements.

### Building Management System and HVAC System

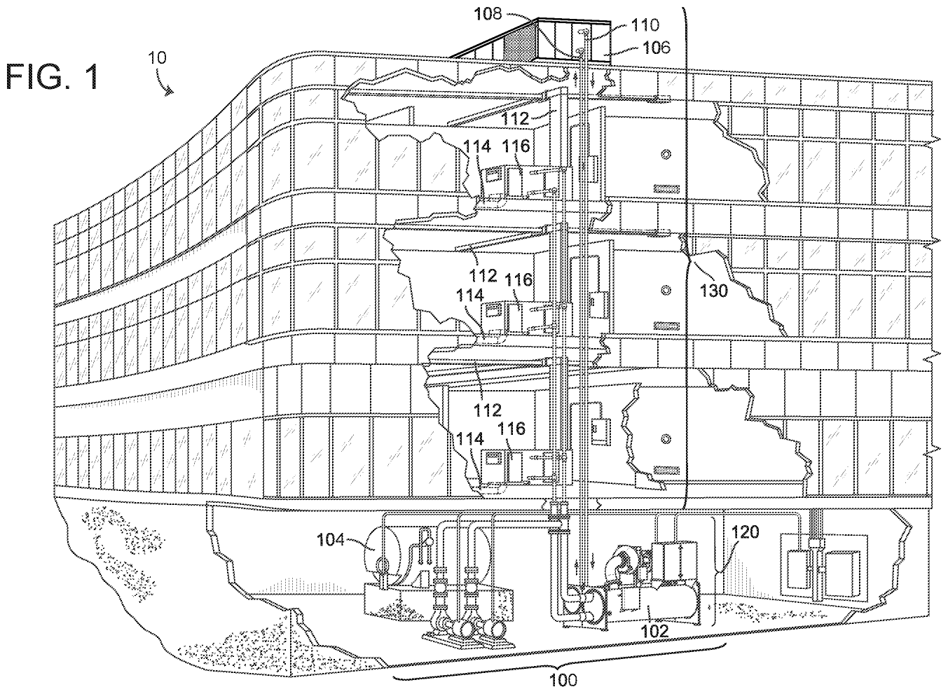

Referring now to FIGS. 1-4, an exemplary building management system (BMS) and HVAC system in which the systems and methods of the present invention may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS may include, for example, an HVAC system, a security system, a lighting system, a fire alerting system, and any other system that is capable of managing building functions or devices, or any combination thereof.

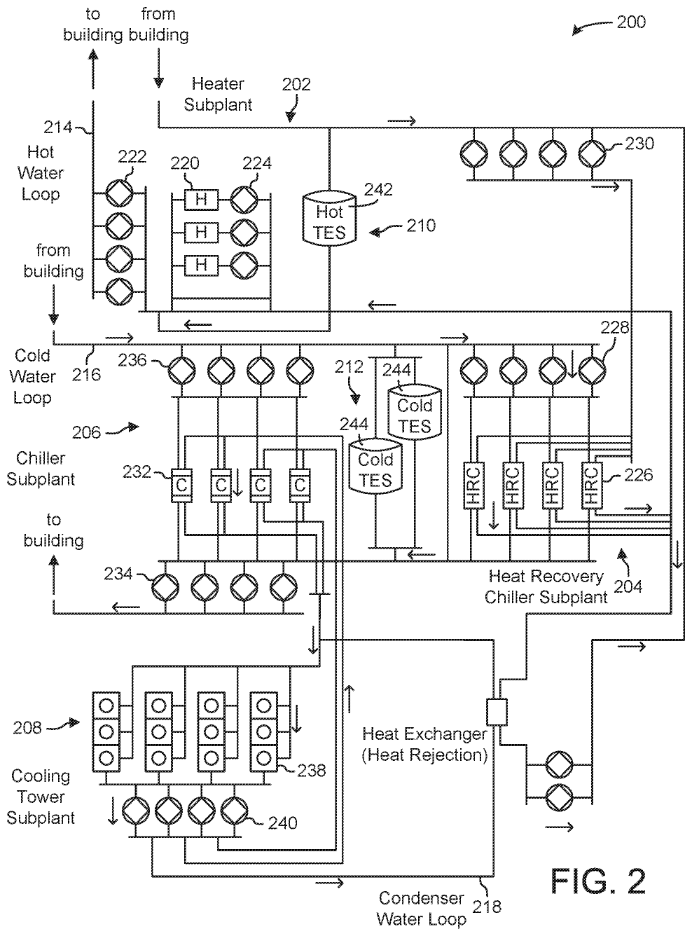

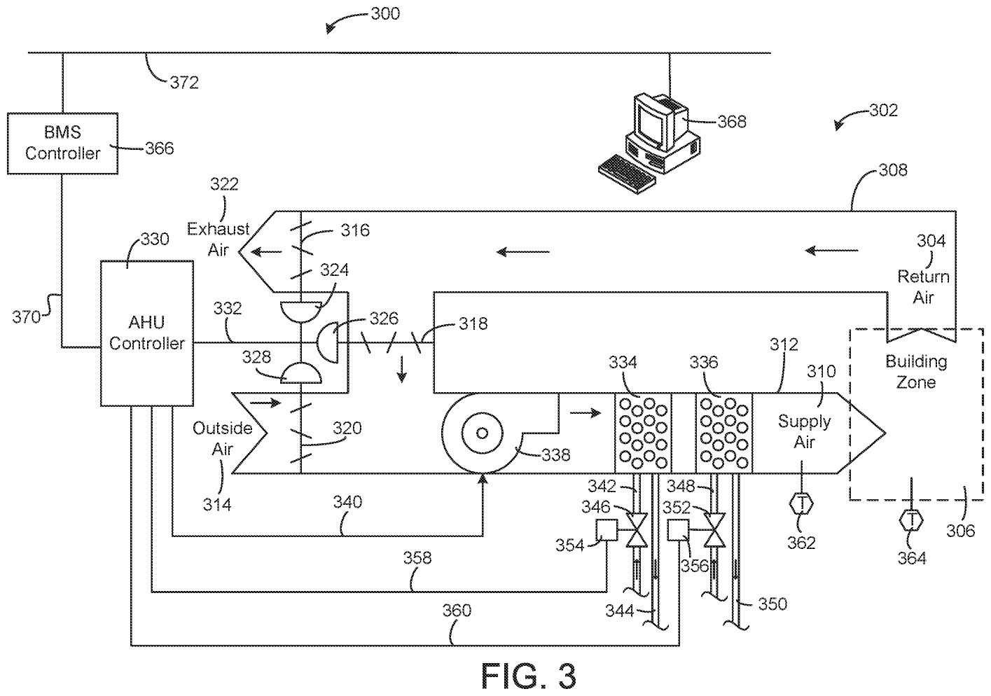

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that may be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve set point conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type AHU 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that may be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that may be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a BMS controller 366 and a client device 368. BMS controller 366 may include one or more computer systems (e.g., servers, supervisory controllers, subsystem controllers, etc.) that serve as system-level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that may be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

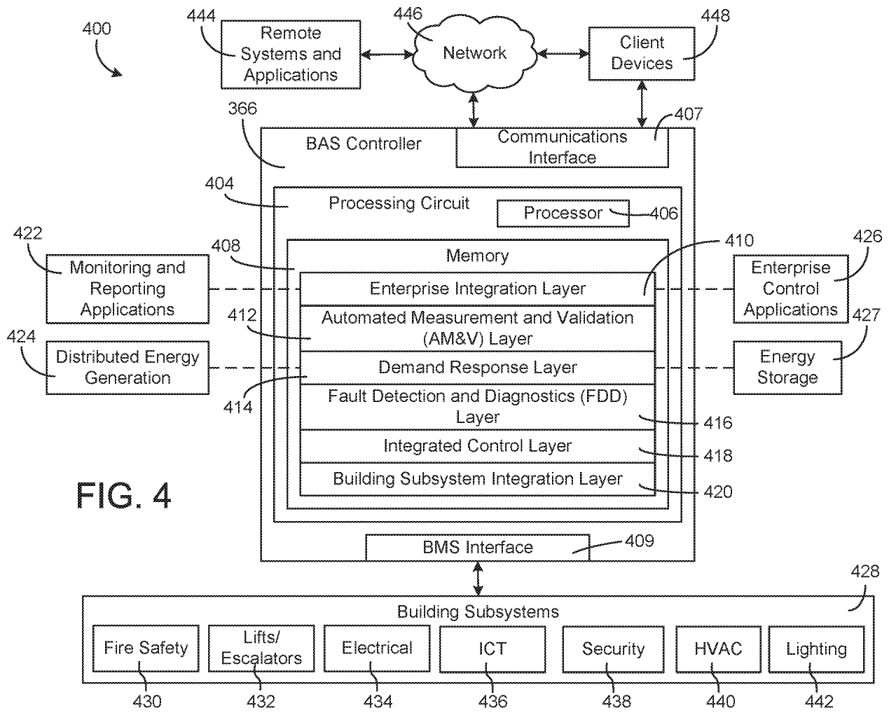

Referring now to FIG. 4, a block diagram of a BMS 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 may include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include any number of chillers, heaters, handling units, economizers, field controllers, supervisory controllers, actuators, temperature sensors, and/or other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407 and 409 may be or may include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407 and 409 may be direct (e.g., local wired or wireless communications) or via a communications network 446 (e.g., a WAN, the Internet, a cellular network, etc.). For example, interfaces 407 and 409 may include an Ethernet card and port for sending and receiving data via an Ethernet-based communications link or network. In another example, interfaces 407 and 409 may include a Wi-Fi transceiver for communicating via a wireless communications network. In another example, one or both of interfaces 407 and 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof may send and receive data via interfaces 407 and 409. Processor 406 may be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that may exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 may work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses may include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions may specify which equipment may be turned on or off in response to particular demand inputs, how long a system or piece of equipment should be turned off, what setpoints may be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 may integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions may be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and AM&V layer 412. Integrated control layer 418 may be configured to provide calculated inputs (e.g., aggregations) to these higher levels based on outputs from more than one building subsystem.

AM&V layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

FDD layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes may be examined by FDD layer 416 to expose when the system begins to degrade in performance and alert a user to repair the fault before it becomes more severe.

### HVAC Actuator

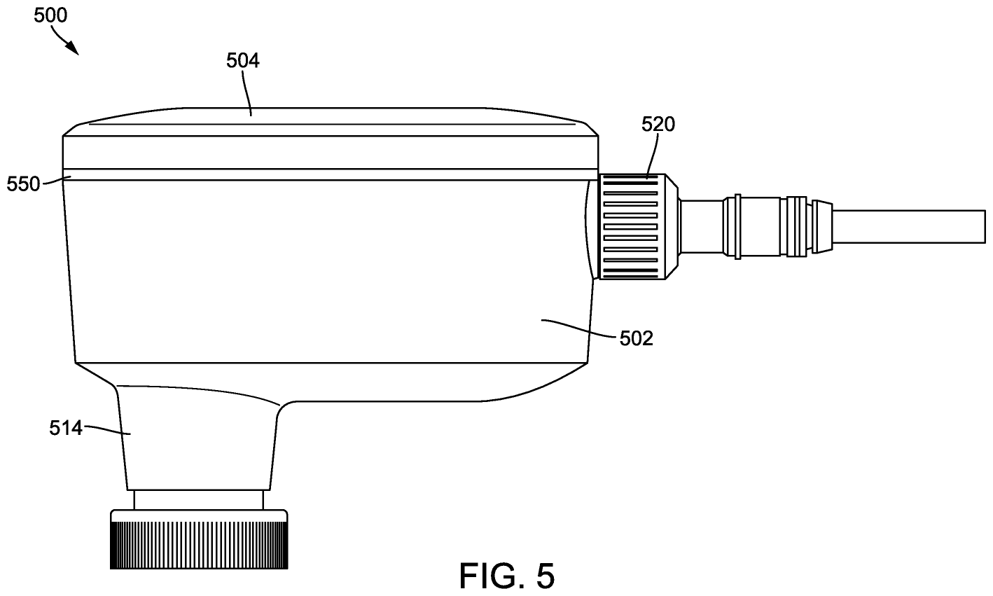

Referring now to FIG. 5, is a view of an actuator 500, according to an exemplary embodiment. In some implementations, actuator 500 may be used in HVAC system 100, waterside system 200, airside system 300, or BMS system 400, as described with reference to FIGS. 1-4. For example, actuator 500 may be a damper actuator, a valve actuator, a fan actuator, a pump actuator, or any other type of actuator that may be used in an HVAC system or BMS. In various embodiments, actuator 500 may be a linear actuator (e.g., a linear proportional actuator), a non-linear actuator, a spring return actuator, or a non-spring return actuator.

Actuator 500 is shown to include a housing 502. Housing 502 may contain the mechanical and processing components of actuator 500 when assembled. In some embodiments, housing 502 contains a brushless direct current (BLDC) motor and a processing circuit configured to provide a pulse width modulated (PWM) DC output to control the speed of the BLDC motor. In other embodiments, the housing 502 may contain other types of motors that are controllable (e.g., by the various processing components of the actuator 500 and/or the HVAC or BMS system 100, 400).

Actuator 500 may generally provide a mechanical output to various devices in the HVAC, waterside, airside, or BMS systems 100, 200, 300, 400. The actuator 500 may be a rotary actuator, a linear actuator, etc. Accordingly, the actuator 500 may provide different types of force outputs depending on configuration.

As shown in FIG. 5, the actuator 500 includes a cover assembly 504 and a housing 502. The cover assembly 504 is configured to engage the housing 502 using a wide variety of engaging various features, for example, a snap-fit design, press fit, or a combination of the two. The cover assembly 504 includes a transparent indicator 550 disposed annularly around the cover assembly 504 and adjacent to the housing 502. In other words, the transparent indicator 550 is disposed between the cover assembly 504 and the housing 502. The transparent indicator 550 is configured to be illuminated in a wide variety of colors and patterns to indicate a status of the actuator 500. In some embodiments, the transparent indicator 550 runs annularly around the entire actuator (e.g., around the circumference).

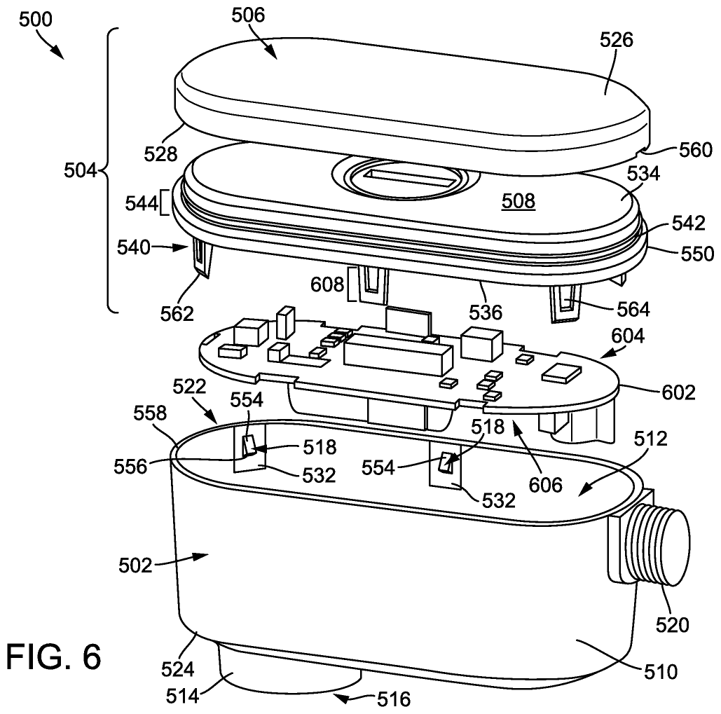

Turning to FIG. 6, an exploded view of the actuator 500 of FIG. 5 is shown, according to an example embodiment. The actuator 500 includes a top cover 506, a middle cover 508, housing 502 (e.g., lower body), and a printed control board 602 (PCB) disposed within the cover assembly 504 and the housing 502. The cover assembly 504 includes top cover 506 and middle cover 508 that are engaged through a snap-fit, press-fit, or other engagement design. As shown in FIG. 6, the transparent indicator 550 is disposed around the middle cover 508.

The housing 502 includes a top or first housing end 522, a bottom or second housing end 524, an outer surface 510 disposed between the first housing end 522 and second housing end 524, and an interior housing surface 512 between the first housing end 522 and second housing end 524. The outer surface 510 and the interior housing surface 512 define the body (e.g., outside and inside, respectively) of the housing 502. The housing 502 includes a cylindrical channel wall 514 extending from the second housing end 524. An output channel 516 is formed within the channel wall 514, which is in communication with the interior housing surface 512.

The channel wall 514 extends from the second housing end 524 and may be substantially cylindrical with openings at an exterior end and an interior end. The channel wall 514 defines an output channel 516 that allows access to the interior housing surface 512 from outside the actuator 500. The channel wall 514 has an interior surface that runs along the output channel 516. The channel wall 514 may have a uniform thickness or may taper towards the exterior end.

The interior housing surface 512 receives a portion of the PCB 602. The PCB 602 may be molded onto, snap-fit with, screwed onto, or otherwise coupled with the interior housing surface 512 or other housing 502 portion. The interior housing surface 512 may receive or support any combination of control systems or circuit boards, electrical, hydraulic, pneumatic, or other power systems, gear trains or other mechanical components, or any other elements useful for the operation of actuator. In some embodiments, the interior volume contains a brushless direct current (BLDC) motor and a processing circuit configured to provide a pulse width modulated (PWM) DC output to control the speed of the BLDC motor. In other embodiments, the housing 502 may contain other types of motors that are controllable (e.g., by the various processing components of the actuator 500 and/or implemented systems).

The actuator 500 may receive power and/or control inputs from a remote source through the socket 520. In some embodiments, actuator 500 may include a cable for receiving power or control inputs. For example, the socket 520 is shown as threaded to engage a coupling device and cable. The actuator 500 may receive inputs and/or power from an overmolded cable (not shown). The overmolded cable may be attached to the housing 502 of the actuator 500 via a coupling device. For example, the coupling devices may be screwed into the socket 520 with a neck of the coupling devices pressed up against a stopper to secure the overmolded cable to the housing 502. The overmolded cable may provide power or control the PCB 602.

A plurality of snapping surfaces 518 are disposed along the interior housing surface 512. A plurality of cantilever snap indentations 532 (e.g., receiving surface) may each be disposed around each snapping surface in the plurality of snapping surfaces 518. Each snap indentation in the plurality of cantilever snap indentations 532 is configured to receive a complementary snap in a plurality of snaps 540 on the middle cover 508 and facilitate the engagement of the middle cover 508 and the housing 502.

As shown in FIG. 5, the cover assembly 504 is a snap-fit body comprising two covers (e.g., the top cover 506 and the middle cover 508) that seal to protect the actuator 500 from humidity and liquid (e.g., water) from splashing into the interior housing surface 512 (e.g., interior housing portion) and disrupting operation. The top cover 506 includes an outer top surface 526 and an internal top surface 528. The internal top surface 528 is configured to engage the middle cover 508. The internal top surface 528 includes an annular groove that is configured to snap-fit interface with a complementary annular snap structure 542 on the middle cover 508. In some embodiments, one or more notches 560 are provided between the outer top surface 526 and an internal top surface 528 to facilitate removal or the top cover 506 and/or the cover assembly from the housing 502. While the top cover 506 is shown as opaque in FIGS. 5 and 6, in some embodiments, the top cover may have some transparent portions to provide additional light source locations for the benefit of the user.

The middle cover 508 includes an outer middle surface 534, a rim 544, and an internal middle surface 536. The outer middle surface 534 includes an annular snap structure 542 and may be configured to include an O-ring groove. The annular snap structure 542 is disposed around a middle portion of the outer middle surface 534 and is configured to engage the annular groove on the internal top surface 528 of the top cover 506 to secure the middle cover 508 and the top cover 506.

A rim 544 extends from a bottom surface of the outer middle surface 534. In some embodiments, the rim may be disposed between the outer middle surface 534 and the internal middle surface 536. As shown in FIGS. 5 and 6, the rim 544 is the transparent indicator 550 (and is used interchangeably throughout the application). As is readily apparent, when the middle cover 508 engages the housing 502, the rim 544 is configured to engage the first housing end 522 in a press-fit or snap-fit manner and is still visible. Specifically, a bottom portion of the rim 544 protrudes axially downward and is configured to engage the O-ring groove 558 on the housing 502, such that an O-ring 552 pressed between the O-ring groove 558 and the bottom portion of the rim 544.

A plurality of snaps 540 protrude from the internal middle surface 536 toward the housing 502 and are configured to engage the plurality of snapping surfaces 518 to secure the middle cover 508 to the housing 502. Each snap in the plurality of snaps 540 is a “U”-shaped snap protrusion 608 with an opening 564 disposed within the center of the snap protrusion 608. Each snap protrusion 608 extends a length from the rim 544. Each snap protrusion 608 is a flexible member with an engagement surface 562 disposed on a tip of the bottom end of the snap protrusion 608. Each engagement surface 562 is configured to come into contact with the top portion 554 of a snap surface in the plurality of snapping surfaces 518 such that the snap protrusion 608 flexes inward as it moves axially along the length of the snapping surface 518 until it axially passes over the rectangular prism bottom portion 556. Once the engagement surface 562 of the snap protrusion 608 passes over the rectangular prism bottom portion 556, the snap protrusion 608 flexes outward and the snap surface is disposed within the opening 564 of the snap protrusion 608 and the middle cover 508 is engage with the housing 502. As is readily apparent, each snap in the plurality of snapping surfaces 518 engages each snap surface in the plurality of snapping surfaces 518 at substantially the same time.

The plurality of snaps 540 are shown as cantilever snap structures having a “U”-shape. Each cantilever snap structure is configured to put equal pressure on the O-rings that are disposed throughout the actuator 500. Six cantilever snap structures are shown in the plurality of snaps 540 and are disposed at various locations along the internal middle surface 536 so that the snap structures do not interfere with the internal components of the actuator 500. Each snap protrusion 608 includes a flexible member at the base of the snap protrusion, or at the location where the snap protrusion 608 engages the internal middle surface 536. The flexible member facilitates the inward and outward radially flexing of each snap protrusion 608 as they engage a complementary snap surface on the housing 502.

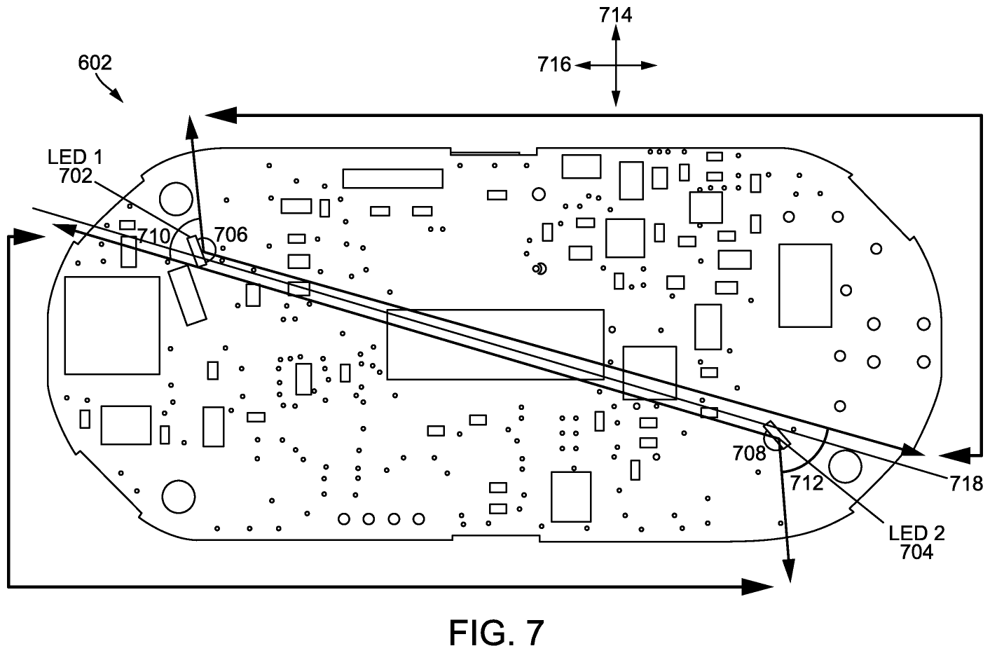

The PCB 602 is positioned within the actuator 500 such that the light emitting diodes (LED) disposed on the top surface 604 of the PCB 602 are substantially coplanar (e.g., aligned) with the transparent indicator 550 when the actuator 500 is assembled. Turning to FIG. 7, a top view of the PCB 602 with a first LED 702 and a second LED 704 is shown, according to an exemplary embodiment. The first LED 702 and the second LED 704 are disposed diagonally from each other on opposite corner portions of the PCB 602, specifically the upper left and lower right portions. In other words, the first LED 702 may be disposed above a latitudinal axis 716 (e.g., left-to-right) of the PCB 602 and to the left of a longitudinal axis 714 (e.g., top-to-bottom) of the PCB 602; the second LED 704 may be disposed below the latitudinal axis 716 of the PCB 602 and to the right of the longitudinal axis 714 of the PCB 602. As will be appreciated, in some embodiments, the first LED 702 may be disposed on the lower left portion of the PCB 602 and the second LED 704 may be disposed on the upper right portion of the PCB 602. The orientation of the first LED 702 is substantially inward at an angle 706 of about 130-degrees with respect to a diagonal axis 718. The diagonal axis 718 is the axis formed between (e.g., aligned, co-planar, etc.) the first LED 702 and the second LED 704. In other words, the diagonal axis extends between the first LED 702 and the second LED 704. In some embodiments, the diagonal axis 718 is the axis that intersects the longitudinal axis 714 and latitudinal axis 716 at a substantially 45-degree angle. The orientation of the second LED 704 is substantially inward at an angle 708 of about 130-degrees with respect to the diagonal axis 718 in a direction opposite to the angle 706 of the first LED 702. As is readily apparent, the first LED 702 and the second LED 704 partially face each other and directly illuminate 260 degrees of the actuator 500. The 50-degree upper left portion 710 and the 50-degree lower right portion 712 are indirectly illuminated by the first LED 702 and the second LED 704 to provide a 360-degree illumination around the transparent indicator 550.

The placement and orientation of the first LED 702 and the second LED 704 are configured to provide an actuator status through a combination of type of light emitted (e.g., partially broken, complete, substantially broken, flashing, etc.) and the color of the light (e.g., blue, green, red, etc.). The orientation of the first LED 702 and the second LED 704 ensures that a user who can view the actuator 500 can determine the status of the actuator 500 because the status color and line type is illuminated 360-degrees along the transparent indicator 550 around the actuator 500. In some embodiments, the top cover 506, middle cover 508, and/or the housing 502 are modified to increase the read distance of the transparent indicator 550 by a user. In some embodiments, the PCB 602 may be configured such that the first LED 702 and the second LED 704 are disposed on the bottom surface 606. In those embodiments, the bottom surface 606 of the PCB 602 is substantially coplanar (e.g., aligned) with the transparent indicator 550.

In some embodiments, the first LED 702 and the second LED 704 are tri-color LED lights with a red, green, and blue color scheme. The luminous intensity (I_{V}) of the red LED is in the range of 90-180 mcd, the green LED is in the range of 140-280 mcd, and the blue LED is in the range of 45-112 mcd. The viewing angle of the first LED 702 and the second LED 704 is 130-degrees relative to the diagonal axis 718. The diagonal axis extends between the first LED 702 and the second LED 704. The peak emission wavelength (λPeak) for the red LED is approximately 632 nm, the green LED is approximately 520 nm, and the blue LED is 468 nm. The dominant emission wavelength (λd) for the red LED is approximately 624 nm, the green LED is approximately 525 nm, and the blue LED is 470 nm. The spectral line half-width (Δλ) for the red LED is approximately 17 nm, the green LED is approximately 35 nm, and the blue LED is 26 nm. The forward voltage (VF) for the red LED is approximately 2.0 V, the green LED is approximately 3.5 V, and the blue LED is 3.5 V. The max forward voltage (VF) for the red LED is approximately 2.4 V, the green LED is approximately 3.8 V, and the blue LED is 3.8 V. The reverse current (IR) for the red LED is approximately 10 μA, the green LED is approximately 10 μA, and the blue LED is 10 μA.

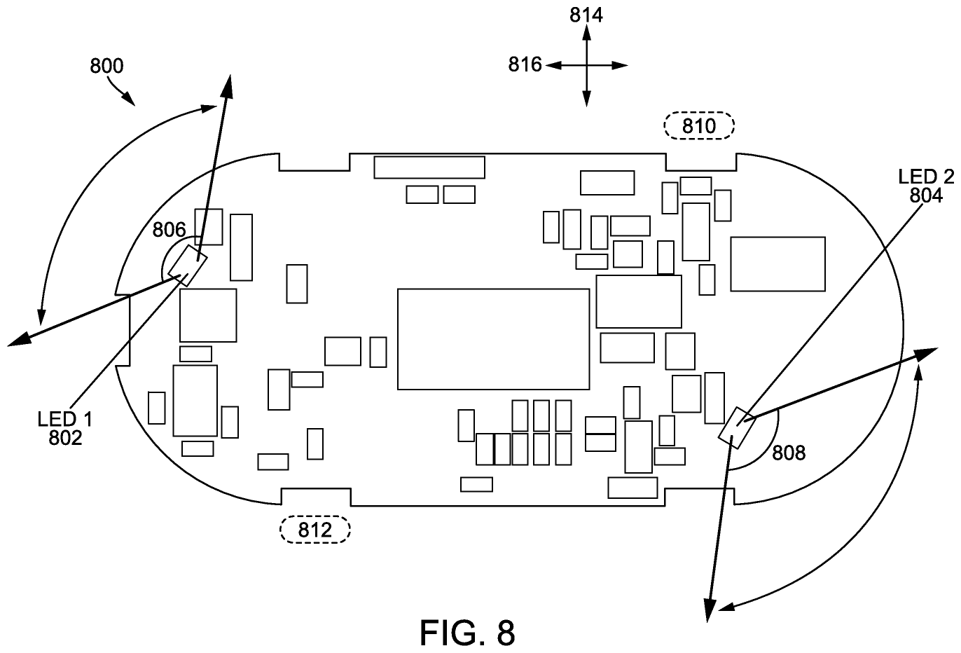

Turning to FIG. 8, a top view of a PCB 800 with a first LED 802 and a second LED 804 is shown, according to an exemplary embodiment. The PCB 800 is similar to the PCB 602 of FIGS. 5-7. A difference between the PCB 800 and the PCB 602 is the orientation of the first LED 802 and the second LED 804 is substantially outward. The first LED 802 and the second LED 804 are disposed diagonally from each other on opposite corner portions of the PCB 800, specifically the upper left and lower right portions. As will be appreciated, the first LED 802 may be disposed on the lower left portion of the PCB 800 and the second LED 804 may be disposed on the upper right portion of the PCB 800. The orientation of the first LED 802 is substantially outward at an angle 806 of about 130-degrees with respect to a longitudinal axis 814. The longitudinal axis 814 runs from “north to south” of the PCB 800. The orientation of the second LED 804 is substantially outward at an angle 808 of about 130-degrees with respect to the longitudinal axis 814. In other words, the second LED 804 is mirrored about the longitudinal axis and latitudinal axis 816 from the first LED 802. As is readily apparent, the first LED 802 and the second LED 804 face away from each other and directly illuminate the upper left corner and lower right corner of the actuator 500, respectively. The upper right portion 810 and the lower left portion 812 are partially indirectly illuminated by the first LED 802 and the second LED 804 to provide a substantially 360-degree illumination around the transparent indicator 550. As a result of the different orientation, the LEDs of the PCB 800 directly illuminates less of the transparent indicator 550 than the LEDs of the PCB 602 illuminate.

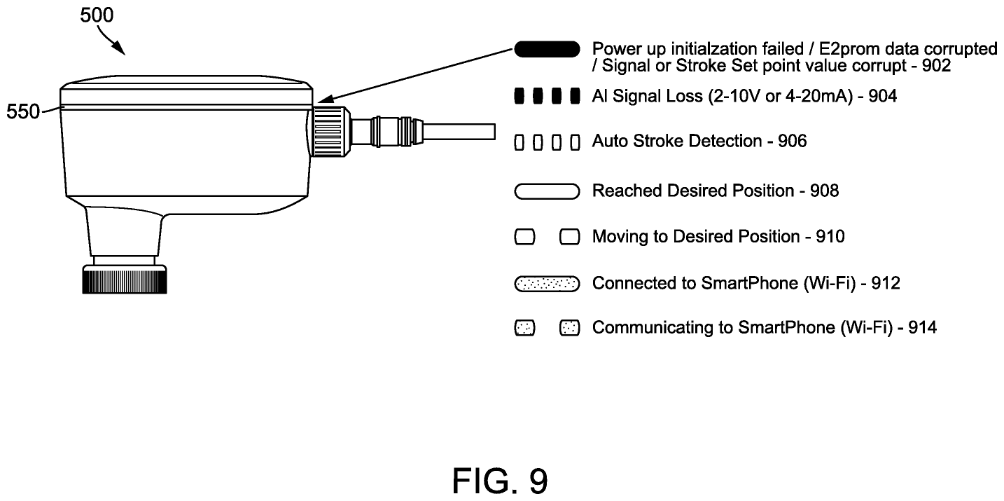

FIG. 9 is a diagram of indicator statuses, according to an exemplary embodiment. The indicator status is seen by the user by looking at the transparent indicator illuminated by the internal LEDs. As is readily apparent, the type of light emitted (e.g., partially broken, complete, substantially broken, flashing, etc.) and the color of the light (e.g., blue, green, red, etc.) allow for many combinations of actuator status indicators. The PCB is configured to cause the internal LEDs to produce light of a certain color and of a certain pattern around the transparent indicator of the actuator. The internal LEDs are configured to produce broken lines, flashing lines, solid lines, patterned lines, and other line configurations by altering the emission of light through one or more of the internal LEDs. Similarly, the internal LEDs are configured to produce a wide variety of single colors or emit multiple colors at the same time along the transparent indicator.

As shown in FIG. 9, the internal LEDs can be configured to produce along the transparent indicator a solid red line 902 that may indicate power up initiation failure, data corruption, a signal or stroke set point value corruption, or other error indicators. A red substantially broken line 904 produced along the transparent indicator may indicate signal loss. A substantially broken green line 906 produced along the transparent indicator may indicate detection of auto stroke. A partially broken green line 910 produced along the transparent indicator may indicate the actuator is moving to a desired position and the partially broken green line may turn into a solid green line 908 produced along the transparent indicator upon the actuator reaching the desired position. A partially broken blue line 914 produced along the transparent indicator may indicate communication with a smartphone or mobile application over Wi-Fi, with the blue line becoming a solid blue line 912 produced along the transparent indicator once a connection is reached between the actuator and smartphone.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision steps.

1.-20. (canceled)

21. An actuator comprising:
a housing; and
a cover assembly coupled to the housing;
an indicator portion configured to be illuminated in a plurality of colors and patterns to indicate a status of the actuator, the indicator portion disposed along a periphery of the actuator.

22. The actuator of claim 21, further comprising a plurality of lights configured to illuminate the indicator portion.

23. The actuator of claim 21, further comprising a circuit board coupled to the plurality of lights.

24. The actuator of claim 21, wherein the plurality of lights comprises a plurality of light emitting diodes (LEDs).

25. The actuator of claim 24, wherein the plurality of LEDs are spaced apart about and adjacent the periphery of the actuator.

26. The actuator of claim 21, wherein the indicator portion comprises a transparent material extending about the periphery to enable passage of light therethrough.

27. The actuator of claim 21, wherein the indicator portion is illuminated 360 degrees about the periphery of the actuator.

28. The actuator of claim 21, wherein the indicator portion is configured to provide an indication of at least one of an initiation failure, data corruption, and a signal value corruption.

29. The actuator of claim 21, wherein the indicator portion is configured to provide an indication of at least one of the actuator moving to a desired position and the actuator reaching a desire position.

30. The actuator of claim 21, wherein the indicator portion is configured to provide an indication of communication with at least one of a smart phone or a mobile application.

31. The actuator of claim 21, wherein the indicator portion is configured to provide an indication of a signal loss.

32. An actuator comprising:
a housing;
a cover coupled to the housing;
an indicator portion extending about an entire perimeter of the actuator and configured to provide a visual indication of a status of the actuator by at least one of:
illumination of the indicator portion with one of a plurality of colors; or
illumination of the indicator portion using one of a plurality of lighting patterns.

33. The actuator of claim 32, wherein the plurality of colors and the plurality of lighting patterns indicate at least one of an initiation failure, data corruption, a signal value corruption, a signal loss, and a connection status.

34. The actuator of claim 32, wherein the visual indication comprises a plurality of light emitting diodes (LEDs).

35. The actuator of claim 34, wherein the plurality of LEDs are configured to provide a variety of single colors or emit multiple colors along the indicator portion.

36. The actuator of claim 34, wherein the plurality of LEDs are spaced apart about the perimeter of the of the actuator.

37. The actuator of claim 32, wherein the indicator portion is configured to provide an indication of communication with at least one of a smart phone or a mobile application.

38. An actuator comprising:
a housing;
a cover coupled to the housing;
an indicator portion extending about an entire perimeter of the actuator; and
a plurality of lights positioned about and adjacent to the perimeter of the actuator and configured to illuminate the indicator portion in a manner based on a status of the actuator.

39. The actuator of claim 38, wherein the plurality of lights are further configured to produce a variety of single colors or emit multiple colors at the same time along the indicator portion.

40. The actuator of claim 38, wherein the indicator portion is configured to provide an indication of communication with at least one of a smart phone or a mobile application.
